(19) United States
(12) Patent Application Publication
(10) Pub. No.: US 2026/0148414 A1
(43) Pub. Date: May 28, 2026

(54) DEEP LEARNING BASED IMAGE GEOREGISTRATION

(71) Applicant: BAE Systems Information and Electronic Systems Integration Inc., Nashua, NH (US)

(72) Inventor: Bingcai Zhang, San Diego, CA (US)

(73) Assignee: BAE Systems Information and Electronic Systems Integration Inc., Nashua, NH (US)

(21) Appl. No.: 18/960,852

(22) Filed: Nov. 26, 2024

(51) Int. Cl. G06T 7/73; G06F 16/29; G06V 10/75; G06V 20/13

(52) U.S. Cl. CPC G06T 7/74; G06F 16/29; G06V 10/75; G06V 20/13

(57) ABSTRACT

A computer program product that includes one or more non-transitory machine-readable mediums encoded with instructions thereon that when executed by one or more processors cause a process to be carried out for georegistering a target of a plurality of targets. The instructions of this computer program product include: load a primary image that has been georegistered; load a secondary image; generate a primary tie feature database from primary tie features detected in the primary image; generate a secondary tie feature image database from secondary tie features detected in the secondary image; match at least one secondary tie feature from the secondary tie feature database with at least one primary tie feature from the primary tie feature database within a first search area; and georegister the secondary image. A method of georegistering an image is also discussed herein.

### TECHNICAL FIELD

Broadly, this disclosure relates to image georegistration. More particularly, this disclosure relates to image georegistration using deep learning methods.

### BACKGROUND ART

Image georegistration is an essential technology and has a wide range of applications in the geospatial intelligence space. Traditionally, image georegistration primarily used area-based image correlation algorithms. For example, the “line-photogrammetry” concept, which uses lines instead of points for georegistration and triangulation, is not widely adapted due to the difficulties of reliability and accurately detecting lines from geospatial images.

### SUMMARY OF THE INVENTION

With deep learning, and the methods disclosed herein, image georegistration is described. In one example, deep georegistration architecture uses both tie points and tie features, for image georegistration and triangulation.

In one aspect, an exemplary embodiment of the present disclosure may provide a method of georegistering an image, comprising: providing a primary image that has been georegistered; providing a secondary image; providing a primary tie feature database from primary tie features detected in the primary image; providing a secondary tie feature image database from secondary tie features detected in the secondary image; tie feature matching at least one secondary tie feature from the secondary tie feature database with at least one primary tie feature from the primary tie feature database within a first search area; and georegistering the secondary image.

In this exemplary embodiment or another exemplary embodiment, the step of tie feature matching further comprises: tie feature matching within a second search area different from the first search area. In this exemplary embodiment or another exemplary embodiment, the method further comprises: narrowing the first search area to a second search area smaller than the first search area; and, tie feature matching at least another secondary tie feature from the secondary tie feature database with at least one primary tie feature from the primary tie feature database within the second search area. In this exemplary embodiment or another exemplary embodiment, the step of tie feature matching further comprises the steps of: forward matching tie features in the primary image with tie features in the secondary image to obtain a first number of tie feature matches; and backward matching tie features in the secondary image with tie features in the primary image to obtain a second number of tie feature matches. In this exemplary embodiment or another exemplary embodiment, the method further comprises: validating the secondary image when the first number of tie features and the second number of tie features equal one another. In this exemplary embodiment or another exemplary embodiment, the method further comprises: invalidating the secondary image when the first number of tie features and the second number of tie features are different from one another. In this exemplary embodiment or another exemplary embodiment, the method further comprises: the step of tie feature matching further comprises: drawing a first pair of lines from the centerpoints of two tie features in the primary image to centerpoints of two tie features in the secondary image. In this exemplary embodiment or another exemplary embodiment, the method further comprises: validating the secondary image when a first number of tie features and a second number of tie features equal one another. In this exemplary embodiment or another exemplary embodiment, the method further comprises: invalidating the secondary image when a first number of tie features and a second number of tie features are different from one another. In this exemplary embodiment or another exemplary embodiment, the method further comprises: drawing a second pair of lines, wherein when the first pair of lines or the second pair of lines are free from intersecting one another between the primary and secondary images, the method further comprises: georegistering the secondary image.

In another aspect, exemplary embodiment of the present disclosure may provide a computer program product including one or more non-transitory machine-readable mediums encoded with instructions thereon that when executed by one or more processors cause a process to be carried out for georegistering a target of a plurality of targets, the instructions comprising: load a primary image that has been georegistered; load a secondary image; generate a primary tie feature database from primary tie features detected in the primary image; generate a secondary tie feature image database from secondary tie features detected in the secondary image; match at least one secondary tie feature from the secondary tie feature database with at least one primary tie feature from the primary tie feature database within a first search area; and georegister the secondary image.

In this exemplary embodiment or another exemplary embodiment, the instructions further comprise: match tie features within a second search area different from the first search area. In this exemplary embodiment or another exemplary embodiment, the instructions further comprise: narrow the first search area to a second search area smaller than the first search area; and, match at least one secondary tie feature from the secondary tie feature database with at least one primary tie feature from the primary tie feature database within the second search area. In this exemplary embodiment or another exemplary embodiment, the instructions further comprise: forward match tie features in the primary image with tie features in the secondary image to obtain a first number of tie feature matches; and backward match tie features in the secondary image with tie features in the primary image to obtain a second number of tie feature matches. In this exemplary embodiment or another exemplary embodiment, the instructions further comprise: validate the secondary image when the first number of tie features and the second number of tie features equal one another.

In this exemplary embodiment or another exemplary embodiment, the instructions further comprise: invalidate the secondary image when the first number of tie features and the second number of tie features are different from one another. In this exemplary embodiment or another exemplary embodiment, the instructions further comprise: draw a pair of lines from the centerpoints of two tie features in the primary image to centerpoints of two tie features in the secondary image. In this exemplary embodiment or another exemplary embodiment, the instructions further comprise: validate tie features in the secondary image when the lines are free from intersecting one another between the primary and secondary images. In this exemplary embodiment or another exemplary embodiment, the instructions further comprise: invalidate tie features in the secondary image when the lines intersect one another between the primary and secondary images. In this exemplary embodiment or another exemplary embodiment, the instructions further comprise: draw a second pair of lines, wherein when the second pair of lines are free from intersecting one another between the primary and secondary images, the instructions further comprise: georegister the tie features in the secondary image.

In another aspect, an exemplary embodiment of the present disclosure may provide a method of georegistering an image, comprising: providing a primary image that has been georegistered; providing a secondary image; providing a primary tie feature database from primary tie features detected in the primary image; providing a secondary tie feature image database from secondary tie features detected in the secondary image; tie feature matching at least one secondary tie feature from the secondary tie feature database with at least one primary tie feature from the primary tie feature database within a first search area; and georegistering the secondary image. In this exemplary embodiment or another exemplary embodiment, the step of tie feature matching further comprises: tie feature matching within a second search area different from the first search area. In this exemplary embodiment or another exemplary embodiment, the method further comprises: narrowing the first search area to a second search area smaller than the first search area; and, tie feature matching at least another secondary tie feature from the secondary tie feature database with at least one primary tie feature from the primary tie feature database within the second search area. In this exemplary embodiment or another exemplary embodiment, the method further comprises: drawing a first pair of lines from the centerpoints of two tie features in the primary image to centerpoints of the two tie features in the secondary image. In this exemplary embodiment or another exemplary embodiment, the method further comprises: validating the secondary image when a first number of tie features and a second number of tie features equal one another. In this exemplary embodiment or another exemplary embodiment, the method further comprises: invalidating the secondary image when a first number of tie features and a second number of tie features are different from one another. In this exemplary embodiment or another exemplary embodiment, the method further comprises: drawing a second pair of lines, wherein when the second pair of lines are free from intersecting one another between the primary and secondary images, the method further comprises: georegistering the secondary image. In this exemplary embodiment or another exemplary embodiment, the method further comprises: forward matching tie features in the primary image with tie features in the secondary image to obtain a first number of tie feature matches; and backward matching tie features in the secondary image with tie features in the primary image to obtain a second number of tie feature matches. In this exemplary embodiment or another exemplary embodiment, the method further comprises: validating the secondary image when the first number of tie features and the second number of tie features equal one another. In this exemplary embodiment or another exemplary embodiment, the method further comprises: invalidating the secondary image when the first number of tie features and the second number of tie features are different from one another.

In another aspect, exemplary embodiment of the present disclosure may provide a computer program product including one or more non-transitory machine-readable mediums encoded with instructions thereon that when executed by one or more processors cause a process to be carried out for georegistering a target of a plurality of targets, the instructions comprising: load a primary image that has been georegistered; load a secondary image; generate a primary tie feature database from primary tie features detected in the primary image; generate a secondary tie feature image database from secondary tie features detected in the secondary image; match at least one secondary tie feature from the secondary tie feature database with at least one primary tie feature from the primary tie feature database within a first search area; and georegister the secondary image. In this exemplary embodiment or another exemplary embodiment, the instructions further comprise: match tie features within a second search area different from the first search area. In this exemplary embodiment or another exemplary embodiment, instructions further comprise: narrow the first search area to a second search area smaller than the first search area; and, match at least one secondary tie feature from the secondary tie feature database with at least one primary tie feature from the primary tie feature database within the second search area. In this exemplary embodiment or another exemplary embodiment, the instructions further comprise: draw a pair of lines from the centerpoints of two tie features in the primary image to centerpoints of two tie features in the secondary image. In this exemplary embodiment or another exemplary embodiment, instructions further comprise: validate tie features in the secondary image when the lines are free from intersecting one another between the primary and secondary images. In this exemplary embodiment or another exemplary embodiment, the instructions further comprise: invalidate tie features in the secondary image when the lines intersect one another between the primary and secondary images. In this exemplary embodiment or another exemplary embodiment, instructions further comprise: draw a second pair of lines, wherein when the second pair of lines are free from intersecting one another between the primary and secondary images, the instructions further comprise: georegister the tie features in the secondary image. In this exemplary embodiment or another exemplary embodiment, instructions further comprise: forward match tie features in the primary image with tie features in the secondary image to obtain a first number of tie feature matches; and backward match tie features in the secondary image with tie features in the primary image to obtain a second number of tie feature matches. In this exemplary embodiment or another exemplary embodiment, instructions further comprise: validate the secondary image when the first number of tie features and the second number of tie features equal one another. In this exemplary embodiment or another exemplary embodiment, instructions further comprise: invalidate the secondary image when the first number of tie features and the second number of tie features are different from one another.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a general flow chart for the image georegistration architecture.

FIG. 2 shows 16 categories of tie features in a tie feature database.

FIG. 3 is an operational view of comparing tie features and tie points for georegistering an image.

FIG. 4A is a flow chart for a hierarchical tie feature matching algorithm of the image georegistration architecture.

FIG. 4B is an operational view of executing the hierarchical tie feature matching algorithm with a primary image and a secondary image.

FIG. 5A is a flow chart of a backward tie feature matching algorithm of the image georegistration architecture.

FIG. 5B is an operational view of executing the backward tie feature matching algorithm to provide forward and backward matching between a primary image and a secondary image algorithm.

FIG. 6A is a flow chart for a double tie feature matching algorithm of the image georegistration architecture.

FIG. 6B is an operational view of executing the double tie feature matching algorithm to compare tie features between a primary image and a secondary image algorithm.

FIG. 7 depicts a flowchart for a preliminary feature matching subroutine of the image georegistration architecture.

FIG. 8 depicts a flowchart for an embodiment of the hierarchical matching algorithm that includes the backward tie feature matching algorithm and the double tie feature matching algorithm.

Similar numbers refer to similar parts throughout the drawings.

### DETAILED DESCRIPTION

Georegistration architecture or georegistration feature model, generally referred to as 10, as described herein is a system and method that facilitates image georegistration using deep learning.

In one embodiment, the georegistration architecture uses two deep learning models: (1) tie feature model; and (2) tie point model. Image georegistration architecture is a general term for BAE's DeepTie™ system and method of image georegistration using deep learning. Disclosed herein in particular is the georegistration tie feature model. Tie features discussed herein provide richer and deeper information than traditional tie points because a variety of tie features having two dimensions (rectangles, circles, arrows) are used for comparison of primary and secondary images rather than only point-matching, for example only the endpoint of a line segment. Analogous to identifying a person, to use the tie point model is to only use a person's nose to identify that person, while the tie feature model uses the whole face of the person for identification. Tie features are more reliable and accurate than tie points. Disclosed herein are newly developed tie feature matching algorithms to reliably and accurately match tie features for images which are taken from different years, different seasons, and from different sensors.

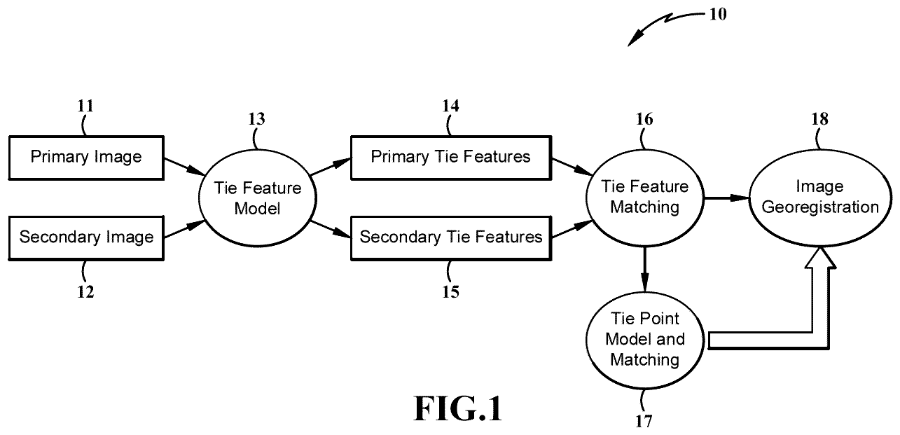

Referring to FIG. 1, the georegistration architecture 10, for image georegistration is shown. There are two input images. A first input or primary image 11 has already been georegistered, and a second input or secondary image 12 is not yet georegistered and therefore needs georegistration. In the present disclosure, georegistration means that an image of a ground feature corresponds with, and has been validated to, the actual ground feature. It is assumed that the secondary image 12 has some initial sensor parameters, which is usually the case in the geospatial intelligence space. This means that the secondary image 12 may be localized to the vicinity of a corresponding primary image 11.

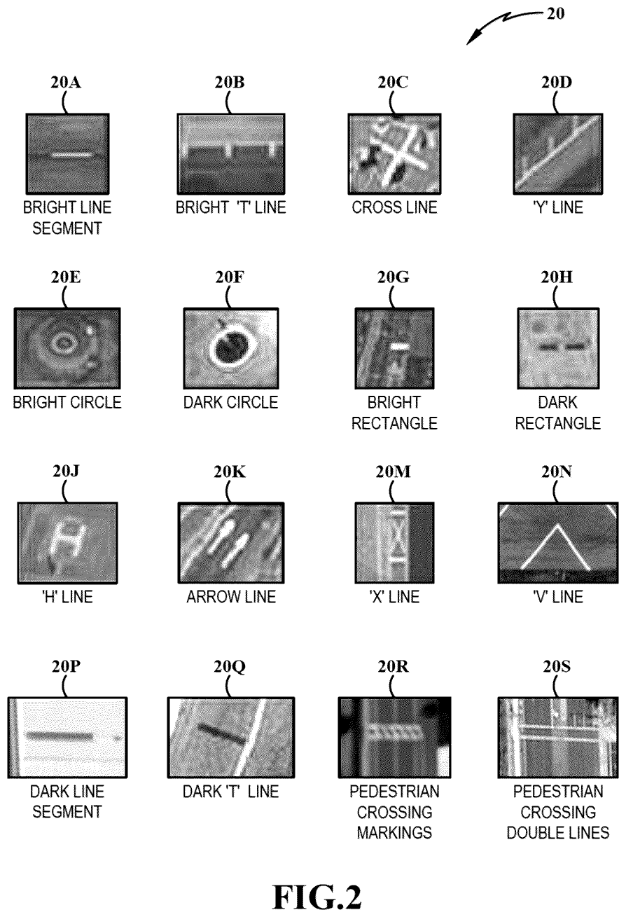

Georegistration architecture 10 also includes a tie feature model 13. In the present disclosure, the tie feature model 13 includes a plurality of tie feature categories 20 (as shown in FIG. 2) that are used to detect tie features from the primary image 11 and from the secondary image 12; each tie feature of the plurality of tie features categories 20 are discussed in greater detail below. As such, the tie feature model 13 is configured to compare the primary image 11 and the secondary image 12 to determine the number of tie features from the plurality of tie feature categories 20 in each image 11, 12. The tie feature model 13 is also configured to output primary tie features 14 and secondary tie features 15 (as shown in FIG. 1) based on the number of tie features from the plurality of tie feature categories 20 detected in the primary image 11 and the secondary image input into the tie feature model 13; as such, primary tie features 14 are tie features of the primary image 11 while secondary tie features are tie features 15 of the secondary image 12.

Further referring to FIG. 1, the tie feature matching algorithms (“tie feature matching,” step 16) are applied to perform tie feature matching. Each of the tie feature matching algorithms discussed hereinbelow fall within the “tie feature matching” step 16 in the georegistration architecture 10 for image georegistration discussed above. The matching results are used for image georegistration. Alternatively, in addition to feature matching, the georegistration point model 17 may be applied to tie points and tie point matching before image georegistration 18.

Tie features are typically more reliable to match than tie points as shown in FIG. 2. Image georegistration establishes a match between tie features between a primary image and a secondary image. Georegistration architecture 10 has been developed to use tie features and tie points for image georegistration. In one exemplary embodiment, georegistration architecture 10 may be capable of detecting at least sixteen categories of tie features and detecting at least twenty categories of tie points from geospatial images, which are discussed in greater detail below. In other exemplary embodiment, the georegistration architecture 10 may detect various tie features and various categories of tie points from geospatial images that are accessible by georegistration architecture 10.

Referring to FIG. 2, the tie feature model 13 of the georegistration architecture 10 includes a plurality of tie feature categories 20 that is used to assist in georegistering a secondary image. In the present disclosure, the following sixteen tie feature categories 20 as seen in FIG. 2 include: SEGMENT_LINE_BRIGHT, 20A; BRIGHT_T_LINE, 20B; CROSS_LINE, 20C; Y_LINE, 20D; BRIGHT_CIRCLE, 20E; DARK_CIRCLE, 20F; BRIGHT_RECTANGLE, 20G; DARK_RECTANGLE, 20H; H_LINE, 20J; ARROW_LINE, 20K; X_LINE, 20M; V_LINE, 20N; SEGMENT_LINE_DARK, 20P; DARK_T_LINE, 20Q; PED_CROSSING_MARKINGS, 20R; PED_CROSSING_DOUBLE_LINES, 20S. FIG. 2 also has the tie feature categories labelled with general names that describe the illustrated tie feature categories. It is envisioned that further tie feature categories will be added in the future, for example traffic markings, directional arrows, runways and more.

Several terms from the preceding paragraph describing one or more tie features of the plurality of tie feature categories 20 are defined. “Bright” generally means white, or brighter than the background. A “line” is generally straight and linear and not as wide as a “rectangle.” “Dark” means generally darker than the background or other features. The tie features Y_LINE, 20D; H_LINE, 20J; ARROW_LINE, 20K; X_LINE, 20M; V_LINE, 20N; DARK_T_LINE, 20Q are self-explanatory as having the letter shape stated in their names. “Pedestrian” markings or lines pertain to crosswalks and are generally lines that are brighter or lighter than the background.

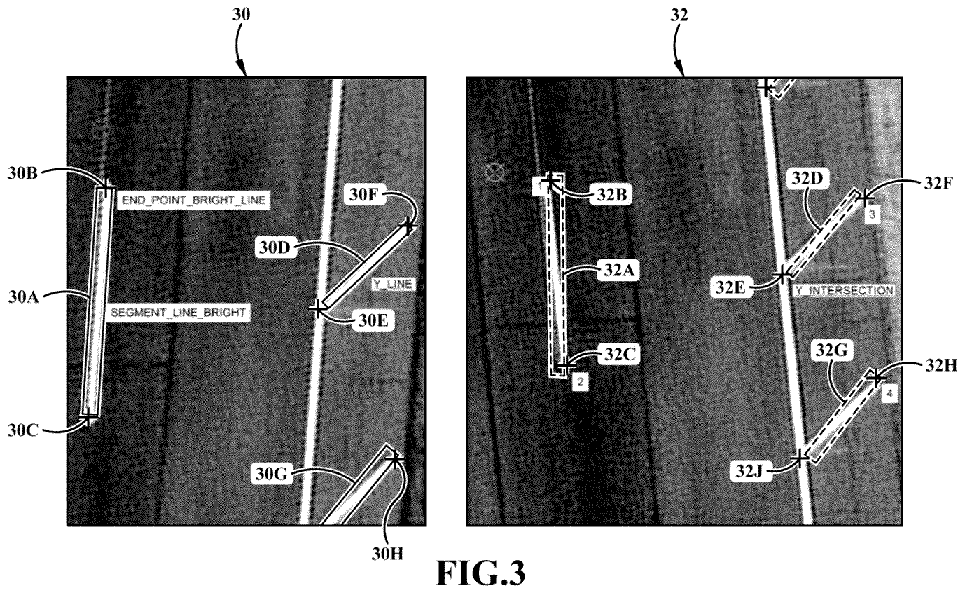

FIG. 3 shows an exemplary pair images where a primary image 30 is a georegistered image and a secondary image 32 needs to be compared with primary image 30 according to the algorithms described below to become georegistered.

In FIG. 3, an exemplary georegistration exercise is depicted where a secondary image, 32, is compared to a primary image 30. FIG. 3 shows two categories of tie features: (1) SEGMENT_LINE_BRIGHT, 30A, 32A; and (2)Y_LINE, 30D, 32D and two categories of tie points: (1) END_POINT_BRIGHT_LINE, 30B, 32B; and (2)Y_INTERSECTION, 30E, 32E, 32J. For the tie points END_POINT_BRIGHT_LINE 30B, 30C in the primary image, there are four candidate matching tie points 32B, 32C, 32F, 32H in the secondary image. A tie point matching algorithm resolves these ambiguities and selects the correct matches for each tie point. When a small area, for example, 20×20 pixels is viewed, rather than the entire picture at each candidate matching tie point in the secondary image, the correct tie point cannot be reliably matched owing to various ambiguities such as the relative angle between the images and the relative sizes of the tie features. It is noted that in FIGS. 3, 4B, 5B, and 6B, certain features like SEGMENT_LINE_BRIGHT are enclosed in solid or dashed rectangles. Lead lines, for example for SEGMENT_LINE_BRIGHT 30A are connected to such rectangles. However, it is understood for the purposes of this disclosure that element 30A refers to the ground feature SEGMENT_LINE_BRIGHT, and not the rectangle. The same goes for other ground features.

In FIG. 3 for the tie feature SEGMENT_LINE_BRIGHT 30A in the primary image 30, there is only one candidate matching tie feature within the same 200×150 pixel region of the secondary image. This makes the tie feature matching very reliable. Once the SEGMENT_LINE_BRIGHT, (30A & 32A) tie feature is matched, the matching results (translations in line and sample coordinates) may be used to constrain the matching of the two Y_LINE (30D & 32D) (30F & 32F) tie features. Once all three tie features (one SEGMENT_LINE_BRIGHT, 30A, 32A and two tie features Y_LINE (30D & 32D) (30F & 32F)) are matched, we may use their matching results to constrain the tie point matching to search a very small region such as a 20×20 pixel region. With a 20×20 pixel search region, the georegistration architecture may unambiguously match the tie point END_POINT_BRIGHT_LINE, 30B, 32B.

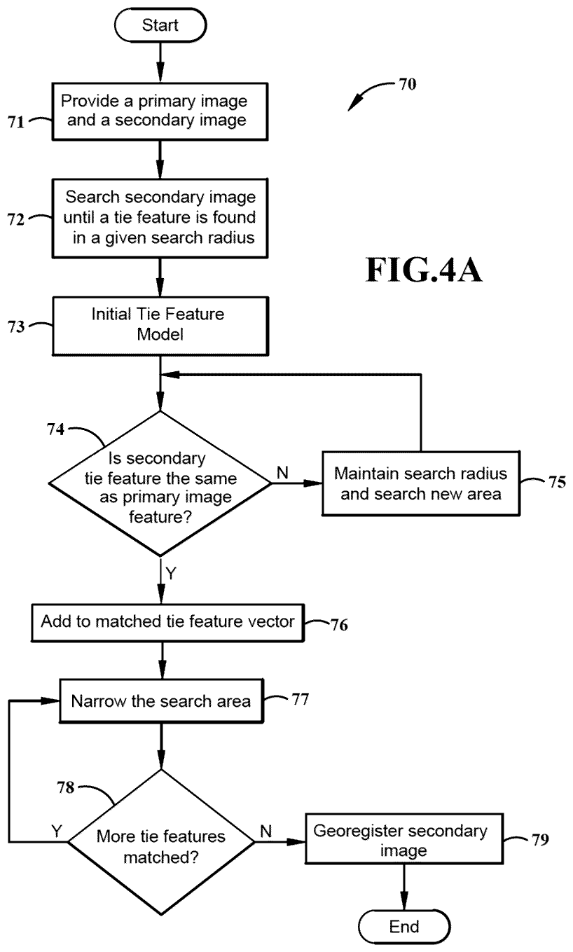

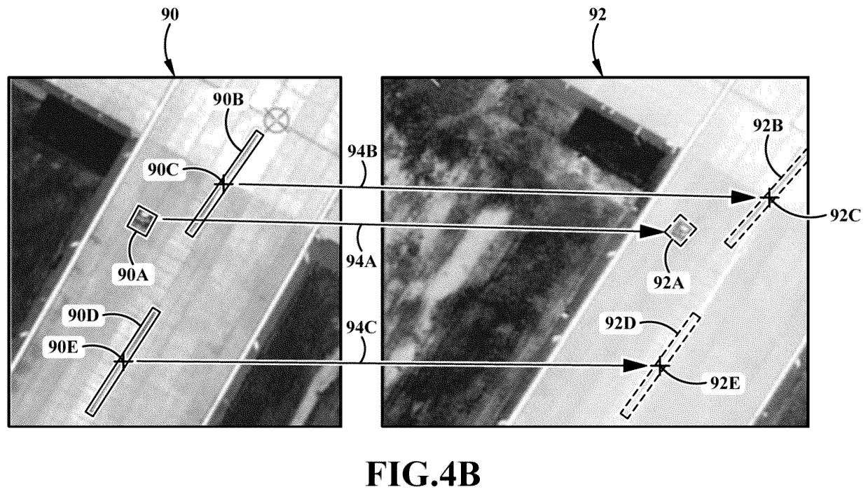

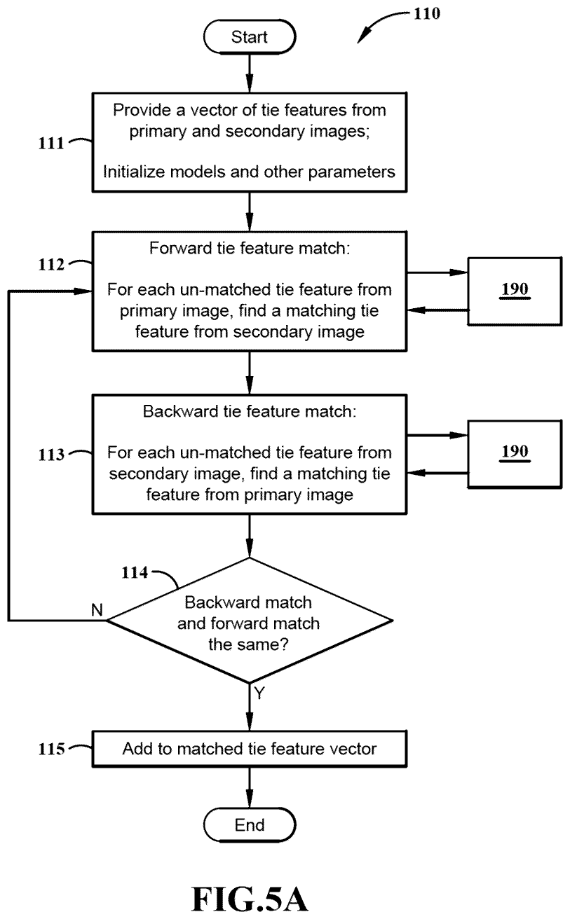

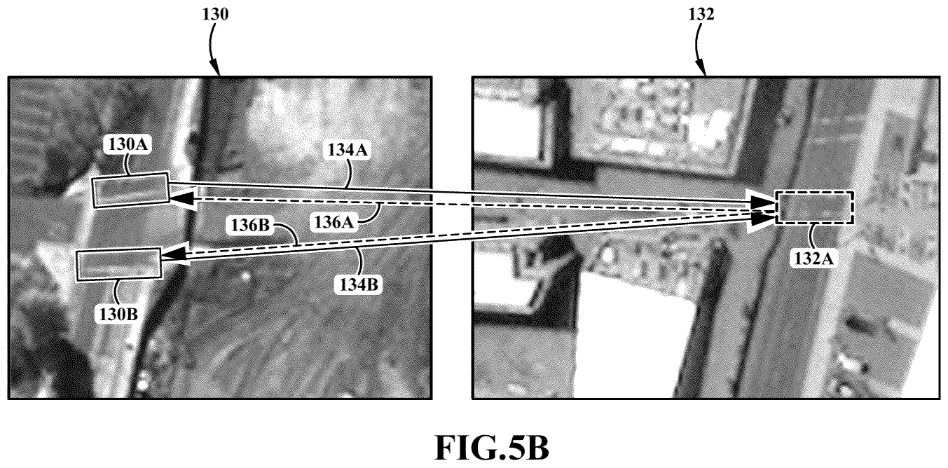

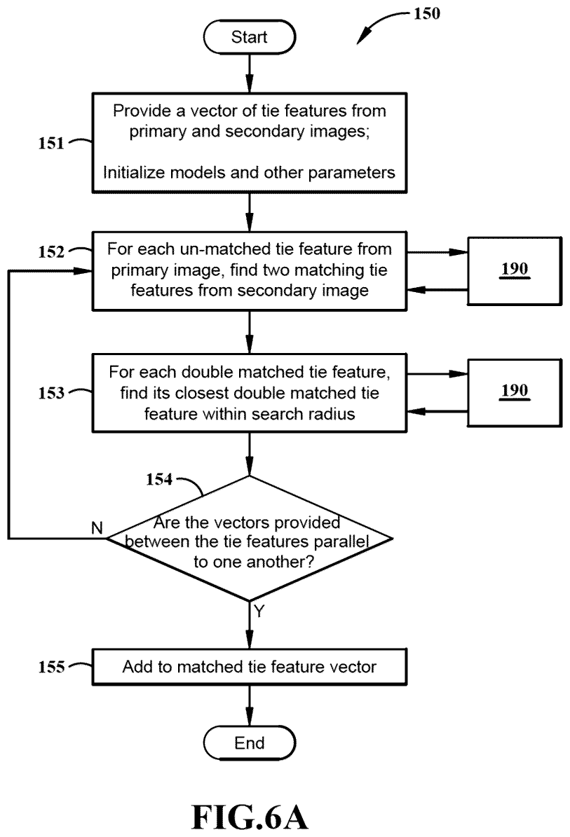

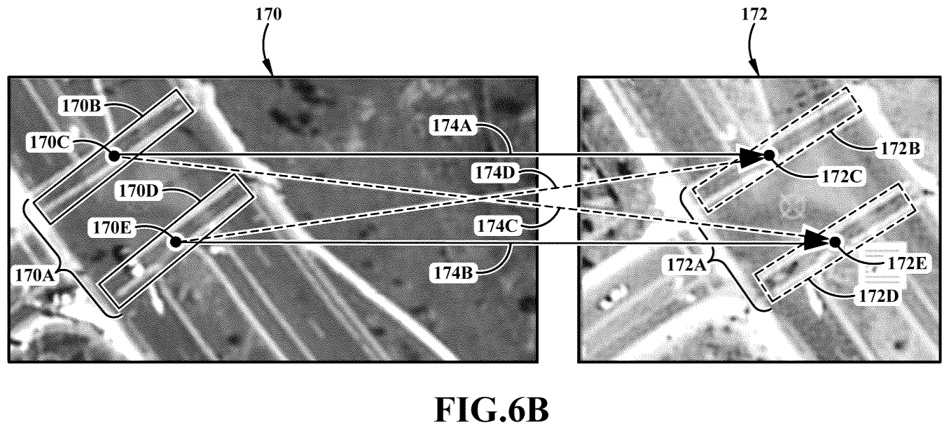

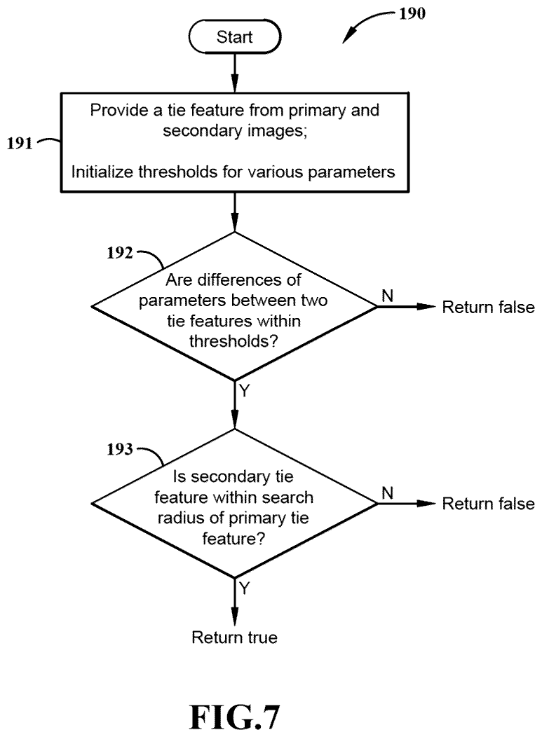

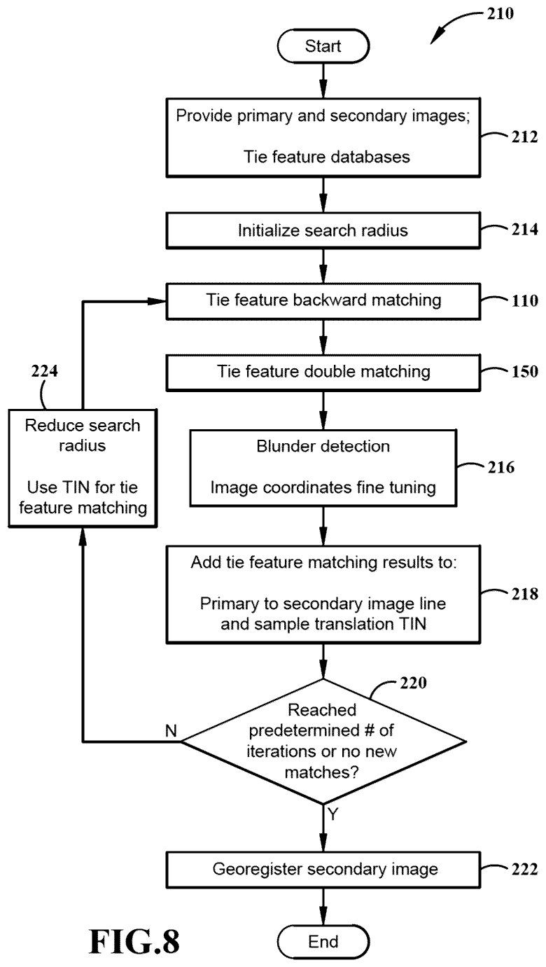

Various algorithms are used to match tie features including: (1) a hierarchical tie feature matching algorithm 70, FIGS. 4A-4B; (2) a backward tie feature matching algorithm 110, FIGS. 5A-5B; and (3) a double tie feature matching algorithm 150, FIGS. 6A-6B. A further algorithm, the preliminary feature matching algorithm, which is a subroutine 190, FIG. 7 is a plug-in subroutine used in the backward tie feature matching algorithm 110 and double tie feature matching algorithm 150. FIG. 8 shows an alternative embodiment of a hierarchical tie feature matching algorithm, 210, that includes one or more algorithms discussed herein for accomplishing complex georegistration between a primary image and a secondary image.

FIGS. 4A, 5A, 6A, and 7 provide flowcharts of the noted algorithms, while FIGS. 4B, 5B and 6B show operational and/or application examples of selected tie feature matching algorithms, corresponding to FIGS. 4A, 5A, 6A, respectively. FIG. 8 provides a flowchart of a combination of the algorithms of FIGS. 4A, 5A, 6A, and 7.

For brevity, the following descriptions provide a general overview of each algorithm 70, 110, 150, 190, 210 discussed herein. It should be noted that steps and/or instructions required in these algorithms 70, 110, 150, 190, 210 are discussed in greater detail below.

With respect to the hierarchical tie feature matching algorithm 70, in FIG. 4A, the hierarchical tie feature matching algorithm 70 compares a secondary image to a primary image. If the secondary image matches the primary image based on the steps or instructions required in hierarchical tie feature matching algorithm 70, then the secondary image is georegistered.

With respect to the backward tie feature matching algorithm 110, the backward tie feature matching algorithm 110, in FIG. 5A, verifies that a secondary image matches a primary image by performing a first operation by checking the features in a first direction from the primary image to the secondary image. The backward tie feature matching algorithm 110 also performs a second operation by checking in a second direction from the secondary image to the primary image. A match in both directions between the primary image and the secondary image validates the match.

With respect to the double tie feature matching algorithm 150, the double tie feature matching algorithm 150, in FIG. 6A, is configured to find two matching features in a secondary image for each unmatched primary tie feature and finds the closest double matched feature within the search radius.

In one embodiment, the backward tie feature matching algorithm 110 and double tie feature algorithm 150 are steps within the hierarchical tie feature matching algorithm 70, while preliminary feature matching subroutine 190 appears in steps 112 and 113 of the backward tie feature matching algorithm 110 as well in steps 152 and 153 of the double match tie feature algorithm 150.

With respect to the preliminary feature matching subroutine 190, the preliminary feature matching subroutine 190, in FIG. 7, determines whether two images of a feature match one another. As discussed previously, such preliminary subroutine 190 may be included and executed in one or both of the backward tie feature matching algorithm 110 and the double tie feature matching algorithm 150.

With the respect to the alternative use of the hierarchical tie feature matching algorithm 210 in FIG. 8, the alternative use compares a secondary image to a primary image. In this embodiment, however, the hierarchical tie feature matching algorithm 210 includes the backward tie feature matching algorithm 110 and the double tie feature matching algorithm 150 when complex georegistration of the secondary image is required (e.g., a plurality of tie features are found in the primary image and/or the secondary image and compared between the primary image and the secondary image).

The algorithms discussed herein are considered advantageous at least because these algorithms are reliable and accurate for large format satellite image georegistration cases. These algorithms assume that tie features are accurately detected from both primary images and secondary images using the georegistration feature model, FIG. 2. The primary image 11 is defined as the image that has been georegistered. The secondary image 12 is defined as image that has not yet been georegistered, but has some initial approximate sensor parameters. In one example, the primary image is an “old” image, while the secondary image is a “new” image.

With respect to the georegistration feature model database 13, the components of which are seen in FIG. 2, the georegistration feature model may detect multiple categories such as sixteen categories of tie features. In other exemplary embodiments, further categories of tie features may be added to georegister a secondary image with a primary image based on the algorithms discussed herein. The criteria for selecting tie features upon executing georegistration architecture 10 follows various parameters to georegister a secondary image with a primary image. First, the tie features should be invariant to seasonal changes. For example, crops and vegetation are subject to seasonal changes and should not be tie features. Second, the tie features should be invariant to angles at which the tie features are viewed. For example, a side edge of a building looks different when the look angles change. Therefore, it should not be a tie feature. Third, the tie features should be distinguishable from their surroundings. This assists the georegistration feature model to accurately detect tie features. Fourth, the tie features should possess rigid geometry in terms of shape and size. Image georegistration requires high positional accuracy when using georegistration architecture 10. A rigid (i.e., unchanging based on look angle) geometric shape helps to accurately locate the centerpoint of the shape when comparing said image between a primary or old image to a secondary or new image.

Referring to FIGS. 4A and 4B, FIG. 4A shows a flow chart of the hierarchical tie feature matching algorithm 70, and FIG. 4B shows an exemplary operation of primary and secondary images 90 and 92 where hierarchical tie feature matching algorithm 70 is used.

Like human vision, the hierarchical tie feature matching algorithm 70 matches tie features in a hierarchical manner. Hierarchical matching involves matching the most important feature first. In one example an important feature is a feature found in the primary and secondary images that allows matching in the first iteration with zero or very low ambiguity. In other exemplary embodiments, such important features may also be predetermined and/or programmed into the hierarchical tie feature matching algorithm 70 based on the types of images being compared and georegistered, if desired.

To start the hierarchical tie feature matching algorithm 70, a primary image 90 and secondary image 92 (FIG. 4B) are provided at step 71. At step 72, for each un-matched tie feature in image 90, the secondary image 92 is searched within a given search radius defining a first radius for a secondary tie feature until a secondary tie feature is found. The search radius utilized in step 72 of hierarchical tie feature matching algorithm 70 refers to a radius that is predetermined or preset in the hierarchical tie feature matching algorithm 70 to detect at least one secondary tie feature within said search radius. The search radius utilized in step 72 is also positioned at a predetermined pixel region in each of the primary image 90 and the secondary image 92 to search a specific area or region of each of the primary image 90 and the secondary image 92. In one exemplary embodiment, a search radius utilized in step 72 may be positioned at a pixel region of 1000 pixels by 1000 pixels in each of the primary image 90 and the secondary image 92 to search a specific area or region of each of the primary image 90 and the secondary image 92 As step 72 is being accomplished, step 73 may then be executed to initialize the tie feature model 13; such execution of step 73 enables the georegistration architecture 10 to refer to the plurality of tie features categories 20 to determine if a tie feature is detected with the search radius performed in step 72. In one exemplary embodiment, step 73 may be executed and/or accomplished before step 72 in order to initialize the tie feature model 13 prior a search radius being applied to the secondary image 92.

Still referring to the hierarchical tie feature matching algorithm 70, the hierarchical tie feature matching algorithm 70 includes step 74 to determine whether the secondary tie feature found in the secondary image 92 is the same as a primary tie feature found in the primary image 90. Stated differently, step 74 is used to determine if the secondary tie feature found in the secondary image 92 is the same or identical to the primary tie feature found in the primary image 90 or if the secondary tie feature found in the secondary image 92 is different than the primary tie feature found in the primary image 90 based on one or more parameters. Examples of measurements or parameters that may be executed in step 74 to determine that the secondary image 92 is the same as a primary tie feature found in the primary image 90 include length differences between primary tie feature and the secondary tie feature, width differences between primary tie feature and the secondary tie feature, and orientation angle differences between primary tie feature and the secondary tie feature. In step 74, a threshold or predetermined value may also be predetermined or preset into hierarchical tie feature matching algorithm 70 for each length difference, width difference, and orientation difference between a primary tie feature of the primary image 90 and a secondary tie feature of the secondary image 92 in order to confirm that secondary image 92 matches with the primary image 90 and the secondary image 92 may be georegistered.

Still referring to hierarchical tie feature matching algorithm 70, step 74 is configured to generate a first or “no” output if such tie features do not match one another or a second or “yes” output if such tie features match one another. If the answer at step 74 is “no”, step 75 of hierarchical tie feature matching algorithm 70 is accomplished when the secondary tie feature of secondary image 92 does not match with the primary tie feature of primary image 90. Continuing with step 75, the search radius initialized in step 72 may be maintained and a new area may be searched for a different secondary tie feature of secondary image 92 to determine if the secondary image 92 matches with the primary image 90. If the answer at step 74 is “yes”, step 76 of hierarchical tie feature matching algorithm 70 is accomplished when the secondary tie feature of the secondary image 92 matches with and/or correlates to a primary tie feature of the primary image 90 based on meeting one of the thresholds mentioned above. At step 76, the primary and secondary tie features matched between the primary image 90 and the secondary image 92 are added to the matched tie feature vector at step 76 in which the secondary tie feature of the secondary image 92 matches the primary tie feature of the primary image 90. At this step, the hierarchical tie feature matching algorithm 70 has determined at least one match between the secondary image 92 and the primary image 90 that is used to assist in georegistering the secondary image 92.

Upon such matching, the search radius may then be narrowed from the first radius performed in step 72 to a second radius in step 77 of hierarchical tie feature matching algorithm 70 to find one or more additional secondary tie features in the secondary image 92 for georegistering secondary image 92; such second radius provided in step 77 is less than the first radius provided in step 72 and is maintained in the same predetermined pixel region provided in step 72. Continuing with hierarchical tie feature matching algorithm 70, steps 72, 74, and 76 may be repeated until no more matched tie features are determined upon accomplishing step 77. As shown in FIG. 4A, such repetition of steps 72, 74, and 76 is denoted in step 78 for brevity. It should be noted that a predetermined number of cycles or rounds of repeating steps 72, 74, and 76 may be preset into hierarchical tie feature matching algorithm 70 once the hierarchical tie feature matching algorithm 70 fails to find any matched tie features in the narrowed search radius performed in step 77. When no further tie features are matched upon completing step 78, then the secondary image is georegistered at step 79 and algorithm 70 ends to stop matching steps between the primary image 90 and the secondary image 92. In one exemplary embodiment, step 79 may be accomplished before steps 77 and 78 if step 76 determines that a secondary tie feature is found in the secondary image 92 that correlates to or matches with a primary tie feature known in the primary image 90; in this exemplary embodiment, steps 77 and 78 may then be omitted.

FIG. 4B illustrates the operation of hierarchical tie feature matching algorithm 70 for georegistering the secondary image 92 based on matching at least one tie feature between the primary image 90 and the secondary image 92. In this example, there is one primary tie feature DARK_RECTANGLE 90A in the primary image 90 and one secondary tie feature DARK_RECTANGLE 92A in the secondary image 92 within a 1000×1000 pixel region as detected by accomplishing steps 72, 73, and 74; it should be noted that primary tie feature 90A is a positive training sample that hierarchical tie feature matching algorithm 70 may rely upon to compare the secondary tie feature 92A with in order to georegister the secondary image 92. Since there is only one such tie feature 90A in the primary image 90 and one such tie feature 92B in the secondary image 92, the matching between the primary and secondary images 90, 92 is reliable without any ambiguity within a 1000×1000 pixel region. In other words, the initial sensor parameters of the secondary image 92 may tolerate errors up to 700 pixels. Therefore, the tie features DARK_RECTANGLE, 90A, 92A may be matched and correlate to one another; such act of matching and correlating the tie features DARK_RECTANGLE, 90A, 92A is denoted by an arrow labeled 94A in FIG. 4B. It should also be noted that such matching of tie features DARK_RECTANGLE, 90A, 92A in the primary and secondary images 90, 92 is performed in steps 74 and 76 so that the hierarchical tie feature matching algorithm 70 may georegister the secondary image 92 due to such matching features between the primary and secondary images 90, 92. Such matching tie features DARK_RECTANGLE, 90A, 92A is a first iteration of feature matching performed in steps 72, 73, 74, and 75.

Once these DARK_RECTANGLEs 90A, 92A are matched, a second iteration of tie feature matching, as shown in FIG. 4B, translations (shifts) in line and sample coordinates between the primary image and 90 the secondary image 92 may also be determined with a much smaller search area or radius (e.g., 15 pixels in accuracy) in this region; such narrowing of the search radius is also performed in steps 77 and 78. Using the translations with such smaller search area or radius, additional tie features, such as SEGMENT_LINE_BRIGHT 90B provided in the primary image 90 and SEGMENT_LINE_BRIGHT 92B provided in the secondary image 92, may be matched without any ambiguity. As accomplished herein, another primary tie feature SEGMENT_LINE_BRIGHT 90B in the primary image 90 having a centerpoint 90C may be matched with another secondary tie feature SEGMENT_LINE_BRIGHT 92B in the secondary image 92 with a centerpoint 92C as indicated by arrow 94B. Similarly, yet another primary tie feature SEGMENT_LINE_BRIGHT 90D having a centerpoint 90E in the primary image 90 may be matched with yet another secondary tie feature SEGMENT_LINE_BRIGHT 92D having a centerpoint 92E in the secondary image 92 as indicated by arrow 94C.

FIG. 5A is a flowchart for the backward tie feature matching algorithm 110, while FIG. 5B is an operational and/or “on the ground” example of performing the backward tie feature matching algorithm 110. In the simplest form, an initial step 111 is configured to provide a vector of tie features from the primary and secondary images along with initializing models and other tie feature parameters discussed in other algorithms herein, including algorithm 70, to georegister a secondary image. Additionally, step 111 may also perform the following instructions or actions to georegister a secondary image: a vector of tie features is provided from a primary image; a vector of tie features is provided from the secondary image; a search radius; an initial sensor model of secondary image; a primary to secondary image line translation TIN; and a primary to secondary image sample TIN. As mentioned herein, TIN is short for “triangulated irregular network”, which is a representation of a continuous surface consisting entirely of triangular facets. Prior to initiating algorithm 110, it should be understood that other models of georegistration architecture 10 discussed herein, such as tie feature model 13, are initialized prior to executing algorithm 110 since algorithm 110 is stored in the tie feature matching model 16 of georegistration architecture 10.

As best seen in FIG. 5B, the execution of first step 111 (along with other steps of algorithm 110) is shown upon analyzing a primary image 130 and a secondary image 132. Here, the primary image 130 and the secondary image 132 display a tie feature, particularly PED_CROSSING_DOUBLE_LINES tie features 130A, 130B in the primary image 130 and only one PED_CROSSING_DOUBLE_LINES tie feature 132A in the secondary image 132, the latter due to fading of the double lines. At this stage, a first pair of vectors or lines 134A, 134B (shown in solid lines) extends from the PED_CROSSING_DOUBLE_LINES tie features 130A, 130B in the primary image 130 to the PED_CROSSING_DOUBLE_LINES tie feature 132A in the secondary image 132. Additionally, a second pair of vectors or lines 136A, 136B (shown in dashed lines) extends from the PED_CROSSING_DOUBLE_LINES tie feature 132A in the secondary image 132 to the PED_CROSSING_DOUBLE_LINES tie features 130A, 130B in the primary image 130.

Once step 111 is accomplished, step 112 of algorithm 110 may then be executed and accomplished. At step 112, a first tie feature matching operation or forward tie feature matching operation (hereinafter “forward matching”) is performed upon using the first pair of vectors or lines 134A, 134B. The term “forward matching” used herein refers to the action of determining matching tie features from at least one tie feature of a primary image (e.g., primary image 130) to at least another tie feature of a secondary image (e.g., secondary image 132). As such, the use of “forward matching” is used when the algorithm 110 is comparing a first tie feature of the primary image 130 with a second tie feature of the secondary image 132. At this step, PED_CROSSING_DOUBLE_LINES tie features 130A, 130B in the primary image 130 are matched with the PED_CROSSING_DOUBLE_LINES 132A tie feature in the secondary image 132 since each PED_CROSSING_DOUBLE_LINES 130A, 130B tie features in the primary image 130 includes a unique and single candidate tie feature that matches with the PED_CROSSING_DOUBLE_LINES 132A tie feature in the secondary image 132 based on one or more measurement parameters that are also used in the algorithm 70 (length, width, and orientation angle as discussed above). In this particular example, step 112 is accomplished since each PED_CROSSING_DOUBLE_LINES 130A, 130B tie feature in the primary image 130 is matched with the PED_CROSSING_DOUBLE_LINES 132A tie feature in the secondary image 132.

Once step 112 is accomplished, step 113 of algorithm 110 may then be executed and accomplished to ensure the match between the PED_CROSSING_DOUBLE_LINES 130A, 130B tie features in the primary image 130 and the PED_CROSSING_DOUBLE_LINES 132A tie feature in the secondary image 132 is corrected. At step 113, a second tie feature matching operation or backward tie feature matching operation (hereinafter “backward matching”) is performed upon using the second pair of vectors or lines 136A, 136B. The term “backward matching” used herein refers to the action of determining matching tie features from a known tie feature of a secondary image (e.g., secondary image 132) to another known tie feature of a primary image (e.g., primary image 130). As such, the use of “backward matching” is used when the algorithm 110 is comparing a tie feature of the secondary image 1302 with another tie feature of the primary image 130. It should be noted that the operation of backward matching is similar to the operation of forward matching but is performed in a reverse order of matching tie features between primary and secondary images 130, 132. Upon execution of setup 113, the backward matching outputs two candidate matching tie features PED_CROSSING_DOUBLE_LINES 130A, 130B in the primary image 130 for the one tie feature PED_CROSSING_DOUBLE_LINES 132A in the secondary image 132. These two candidate matching features with similar attributes (length, width, and orientation angle as discussed above) creates a different output as compared to the forward matching performed in step 112 where a single candidate matching tie feature was found between PED_CROSSING_DOUBLE_LINES 130A, 130B in the primary image 130 for the one tie feature PED_CROSSING_DOUBLE_LINES 132A in the secondary image 132. Since the result of the backward matching accomplished in step 113 does not correspond to the result of the forward tie feature matching step 112, the match is not validated due. The algorithm 110 may then recycle back to step 112, where forward and backward tie feature matching algorithms may be run again on a different tie feature.

In the example at hand, the forward matching accomplished in step 112 succeeds (FIG. 5A, step 114, “yes”) but the backward tie feature matching algorithm fails (FIG. 5A, step 114, “no”) accomplished in step 113 so such feature matching between the primary image 130 and the secondary image 132 fails. The backward tie feature matching algorithm 110 succeeds only when both forward matching operation accomplished in step 112 and backward matching operation accomplished in step 113 succeed in finding the same or identical number of unique candidate feature matches between a primary image and a secondary image. When the number of unique candidate features output by backward matching operation of step 113 equals the number of unique candidate features output by forward matching operation of step 112, then the matched features are added to a matched tie feature vector at step 115. The backward tie feature matching algorithm 110 may reduce false matches, which is required in image georegistration. Upon completing step 115 of algorithm 110, the secondary image is then georegistered.

Referring to FIGS. 6A and 6B, the double tie feature matching algorithm 150 is shown with a corresponding flow chart (in FIG. 6A) and operation of the double tie feature matching algorithm 150 (in FIG. 6B). Similar to human vision, the double tie feature matching algorithm 150 matches two features instead of one feature. For example, it is common that there are two parallel tie features, such as PED_CROSSING_DOUBLE_LINES, 170A, 172A, at an intersection as shown in FIG. 6B. As discussed in greater detail below, at least four lines or vectors connecting centerpoints of two tie features from a primary image to a secondary image assist in determining whether the secondary image may be georegistered.

In the simplest form, an initial step 151 is configured to provide a vector of tie features from the primary and secondary images along with initializing models and other tie feature parameters discussed in other algorithms herein, including algorithms 70, 110, to georegister a secondary image. Additionally, step 111 may also perform the following instructions or actions to georegister a secondary image: a vector of tie features is provided from a primary image; a vector of tie features is provided from the secondary image; a search radius; an initial sensor model of secondary image; a primary to secondary image line translation TIN; and a primary to secondary image sample TIN. Prior to initiating algorithm 150, it should be understood that other models of georegistration architecture 10 discussed herein, such as tie feature model 13, are initialized prior to executing algorithm 150 since algorithm 150 is stored in the tie feature matching model 16 of georegistration architecture 10.

At step 151, lines or vector are then drawn between the centerpoints 170C and 170E of primary image 170 and centerpoints 172C and 172E of secondary image double tie feature 172 along with the matching tie feature being added to the matched feature vector. Particularly, a first set of vectors 174A, 174B (shown in solid lines) extends from the centerpoints 170C and 170E of primary image 170 and the centerpoints 172C and 172E of secondary image 172 where a first vector 174A extends from a first centerpoint 170C of primary image 170 to a first centerpoint 172C of secondary image 172 and a second vector 174B extends from a second centerpoint 170E of primary image 170 to a second centerpoint 172E of secondary image 172. Additionally a second set of vectors 174C, 174D (shown in dashed lines) extends from the centerpoints 170C and 170E of primary image 170 and the centerpoints 172C and 172E of secondary image 172 where a third vector 174C extends from first centerpoint 170C of primary image 170 to second centerpoint 172E of secondary image 172 and a fourth vector 174D extends from second centerpoint 170E of primary image 170 to first centerpoint 172C of secondary image 172.

As best seen in FIG. 6B, a primary image 170 and a secondary image 172 are analyzed by algorithm 150 based on at least two matching tie features detected in each image 170, 172. It should be noted that algorithm 150 is configured to georegister the secondary image 172 upon detecting and confirming at least two matching tie features or double matching tie features between the primary image 170 and the secondary image 172. In this example, primary image 170 includes a first double tie feature (PED_CROSSING_DOUBLE_LINES) 170A that has a first portion 170B with a first centerpoint 170C and a second portion 170D with a second centerpoint 170E. In this same example, secondary tie feature (PED_CROSSING_DOUBLE_LINES) 172A also includes a first portion 172B with a first centerpoint 172C and a second portion 172D with a second centerpoint 172E.

Upon such completion of step 151, step 152 of algorithm 150 may then be accomplished by detecting or finding two matching tie features from the secondary image 172 for each un-matched tie feature from primary image 170. The output from step 152 at least two matching tie features or double matched tie features between the primary image 170 and the secondary image 172. As seen in FIG. 6B, the second double tie features (PED_CROSSING_DOUBLE_LINES) 172A are detected in the secondary image 172 that match with the first double tie features (PED_CROSSING_DOUBLE_LINES) 170A of the primary image 170; such detection is denoted by dashed lines surrounding the second double tie features (PED_CROSSING_DOUBLE_LINES) 172A in the secondary image 172 which the first double tie features (PED_CROSSING_DOUBLE_LINES) 170A of the primary image 170 are surrounded by solid lines.

Upon such completion of step 152, step 153 of algorithm 150 may then be accomplished by finding the closest double matched tie feature for each respective double matched tie feature within the search radius is found. Stated differently, the execution of step 153 finds or detects the double matched tie feature provided in a primary image that is closest in proximity said double matched tie feature provided in a secondary image. As best seen in FIG. 6B, step 153 is accomplished by the matching the first double tie features (PED_CROSSING_DOUBLE_LINES) 170A of the primary image 170 with the second double tie features (PED_CROSSING_DOUBLE_LINES) 172A of the secondary image 172.

Upon such completion of step 153, step 154 of algorithm 150 may then be accomplished by determining a set of vectors provided between double tie features of the primary image 170 and the secondary image 172 remain parallel to one another. In a first operation, step 154 may generate a first output or “yes” output (denoted by an arrow labeled “Y” in FIG. 6A) when a set of vectors provided between double tie features of the primary image 170 and the secondary image 172 are parallel to one another. With such first output, step 155 is then accomplished by adding a matched tie feature vector between a first double tie feature of a primary image and a second double tie feature of a secondary image due to such double tie features of the primary and secondary images matching one another. In a second operation, step 154 may generate a second output or “no” output (denoted by an arrow labeled “N” in FIG. 6A) when a set of vectors provided between double tie features of the primary image 170 and the secondary image 172 intersect one another and/or are non-parallel to one another. With such second output, step 154 then returns to step 152 to determine if a secondary image includes another double tie feature that would match with the un-matched double tie feature of a primary image. It should be noted that a predetermined number of cycles or rounds of repeating 152, 153, and 154 may be preset into algorithm 150 once the algorithm 150 fails to find a double tie feature in the secondary image.

As best seen in FIG. 6B, the first set of vectors 174A, 174B is provided between the first double tie feature (PED_CROSSING_DOUBLE_LINES) 170A of the primary image 170 with the second double tie feature (PED_CROSSING_DOUBLE_LINES) 172A of the secondary image 172. With respect to the first set of vectors 174A, 174B, the first vector 174A that extends between the first portion 170B of the first double tie features (PED_CROSSING_DOUBLE_LINES) 170A and the first portion 172B of the second double tie features (PED_CROSSING_DOUBLE_LINES) 172A is parallel to and/or are free from intersecting with the second vector 174B that extends between the second portion 170D of the first double tie features (PED_CROSSING_DOUBLE_LINES) 170A and the second portion 172D of the second double tie features (PED_CROSSING_DOUBLE_LINES) 172A. With such spatial relationship between the first vector 174A and the second vector 174B, step 154 generates a first output or “yes” output which, in turn, accomplishes step 155 by adding a matched tie feature vector between first double tie feature 170A of primary image 170 and the second double tie feature 172A of secondary image 172. In this situation, the secondary image 172 would then be georegistered upon completion of step 151, 152, 153, 154, and 155.

Still referring to FIG. 6B, the second set of vectors 174C, 174D is also provided between the first double tie feature (PED_CROSSING_DOUBLE_LINES) 170A of the primary image 170 with the second double tie feature (PED_CROSSING_DOUBLE_LINES) 172A of the secondary image 172. With respect to the second set of vectors 174C, 174D, the third vector 174C that extends between the first portion 170B of the first double tie features (PED_CROSSING_DOUBLE_LINES) 170A and the second portion 172D of the second double tie features (PED_CROSSING_DOUBLE_LINES) 172A intersects with the fourth vector 174D that extends between the second portion 170D of the first double tie features (PED_CROSSING_DOUBLE_LINES) 170A and the first portion 172B of the second double tie features (PED_CROSSING_DOUBLE_LINES) 172A. With such spatial relationship and intersection between the third vector 174C and the fourth vector 174D, step 154 generates a second output or “no” output which, in turn, returns to step 152 to determine if a secondary image includes another double tie feature that would match with the un-matched double tie feature of a primary image.

In the double tie feature matching algorithm 150, a RANSAC (random sampling and consensus) algorithm is used to determine the final match as noted above and shown in FIG. 6A. As stated above, the double-tie feature matching algorithm 150 selects the pairs of lines that do not intersect (e.g., lines 174A, 174B shown in FIG. 6B). The double tie feature matching algorithm 150 may be extended to three, four or more double tie features in the future when there are such cases.

FIG. 7 shows the preliminary feature matching subroutine 190, which is a plug-in subroutine used in the backward tie feature matching algorithm 110 and double tie feature matching algorithm 150. The preliminary feature matching subroutine 190, determines whether two images of a feature match one another. At step 191, two tie feature are provided from the primary and secondary images, and thresholds for various parameters are initialized; at step 192, it is determined whether the differences of parameters between two tie features are within the thresholds. If “no,” the subroutine 190 returns a “false” response to either the backward tie feature matching algorithm 110 or the double tie feature matching algorithm 150. If “yes,” the subroutine 190 returns a “true” response to either the backward tie feature matching algorithm 110 or the double tie feature matching algorithm 150. A “true” response at step 192 leads to step 193, where it is determined whether the secondary tie feature is within the search radius of the primary tie feature. If “no,” the subroutine 190 returns a “false” response to either the backward tie feature matching algorithm 110 or the double tie feature matching algorithm 150. If “yes,” the subroutine 190 returns a “true” response to either the backward tie feature matching algorithm 110 or the double tie feature matching algorithm 150.

In the backward tie feature matching algorithm 110, step 112 is the forward tie feature match where the algorithm 110 finds a matching tie feature from the secondary image. Next, subroutine 190 (FIG. 7) is invoked, which is an preliminary feature matching algorithm. Both the forward tie feature match step 112 and the back tie feature match step 113 use the preliminary feature matching subroutine 190, which simply compares two images and returns whether they are the same or not. If, at step 114, the results of the back tie feature matching step 113 and forward tie feature match step 112 return the same feature, then the matched feature is added to the matched tie feature vector at step 115. Otherwise, the algorithm 110 circles back from step 114 to step 112.

Similarly, the double tie feature matching algorithm 150 (FIG. 6A) uses the preliminary feature matching subroutine 190. For step 152 (match secondary image features with an unmatched primary tie feature) and step 153 (find closest double matched tie feature), the preliminary feature matching subroutine 190 is used.

Referring to FIG. 8, a flow chart of a modified hierarchical tie feature matching algorithm 210 is shown. At step 212, primary and secondary images are provided along with two tie feature databases from the primary and secondary images. A search radius based on initial sensor model error of the secondary image is initialized at step 214. At step 110, the backward tie feature matching algorithm is engaged (see FIG. 5A). Next, the double tie feature matching algorithm 150 is engaged (FIG. 6A).

Blunder detection, step 216 is run next to detect obvious errors and fine tune the matches. In this disclosure, blunder detection refers to an algorithm to find blunders or mis-matches based on an assumption that a plurality of tie features matches is correct. It should be understood that blunder detection, and other similar algorithms of the like, are widely used and documented in photogrammetric bundle adjustment. The matching results from backward tie feature matching algorithm 110 and tie feature double matching algorithm 150 are next added at step 218 to the primary to secondary image line translation TIN and the primary to secondary image sample translation TIN. TIN means triangulated irregular network, which is a representation of a continuous surface consisting entirely of triangular facets. At step 220, it is determined whether a predetermined number of iterations has been reached, or, whether there are no new matches. If the answer to either is “no,” the algorithm reduces the search radius at step 224 and circles back to the backward tie feature matching algorithm, at step 110. If the answer to both is “yes,” the secondary image is georegistered at step 222, and the algorithm ends.

Various combinations and sequences of the several described algorithms may be used. In one example, hierarchical tie feature matching algorithm 70 may be executed alone. In another example, (i) hierarchical tie feature matching algorithm 70, (ii) tie feature back match algorithm 110, and (iii) tie feature double match algorithm 150 are executed in sequence. In another example, (i) hierarchical tie feature matching algorithm 70, (ii) tie feature double match algorithm 150, and (iii) tie feature back match algorithm 110 are executed in sequence. In another example, (i) hierarchical tie feature matching algorithm 70 and (ii) tie feature back match algorithm 110 are executed in sequence. In another example, (i) hierarchical tie feature matching algorithm 70 and (ii) tie feature double match algorithm 150 are executed in sequence. In another example, modified hierarchical tie feature matching algorithm 210 (FIG. 8) is executed alone.

Two georegistration feature models have been trained: (1) GoogleNet with resolution of 170 pixels; and (2) EfficientNet with resolution of 110 pixels. Both networks are hyper-parameter fine-tuned for the georegistration feature models. A hyperparameter is a parameter which specifies details of the learning process, as opposed to parameters which determine the model itself.

In one exemplary embodiment, training of the model involved the use of 6,355 positive training samples and 21,100 negative training samples. A positive training sample is an image that appears identical or similar to the image that is being trained. A negative training sample is an image that appears different from the image that is being trained. BAE's DeepObject™ technology is used to train georegistration feature models, such training involving panchromatic satellite images. DeepObject™ is an image analysis system that uses deep learning to detect geospatial objects automatically from geospatial imagery and 3-D point clouds.

The georegistration feature model and tie feature matching algorithms may accurately georegister large format satellite images, which are taken from different years and different seasons with significant real-world changes. The georegistration feature model, based on deep learning, may accurately detect tie features, which are invariant to time and seasons, and have rigid geometry shapes and sizes. By adding more and more training samples in the future, the accuracy of the georegistration feature model will continue to improve. Currently, the georegistration feature model may detect sixteen categories of tie features, However the number of categories may be indefinitely extended in the future without any software changes.

It should be understood that terms “georegistration”, “image registration”, and other derivative terms used herein are intended to be defined in the same manner as intended by the inventor. It should also be understood that once the tie feature step 16 is completed in the georegistration architecture 10 and a tie feature is matched between a primary image and a secondary image, by executing one or more algorithms discussed herein, the secondary image is automatically georegistered and/or image registered since the primary image was previously georegistered and/or image registered by feature matching algorithms discussed herein or other algorithms or programs that may be used in this art.

As described herein, aspects of the present disclosure may include one or more electrical other similar secondary components and/or systems therein. The present disclosure is therefore contemplated and will be understood to include any necessary operational components thereof. For example, electrical components will be understood to include any suitable and necessary wiring, fuses, or the like for normal operation thereof. Alternatively, where feasible and/or desirable, various components of the present disclosure may be integrally formed as a single unit.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, perimeter of the shadow mask gasket may be semi-circular triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of components A and B, then there may be inventive subject matter in the combination of A and B, A alone, or B alone, unless otherwise stated herein.

As used herein in the specification and in the claims, the term “effecting”or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it may be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” may encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention”in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A method of georegistering an image, comprising:
providing a primary image that has been georegistered;
providing a secondary image;
providing a primary tie feature database from primary tie features detected in the primary image;
providing a secondary tie feature image database from secondary tie features detected in the secondary image;
tie feature matching at least one secondary tie feature from the secondary tie feature database with at least one primary tie feature from the primary tie feature database within a first search area; and
georegistering the secondary image.

2. The method of claim 1, wherein the step of tie feature matching further comprises:
tie feature matching within a second search area different from the first search area.

3. The method of claim 1, further comprising:
narrowing the first search area to a second search area smaller than the first search area; and,
tie feature matching at least another secondary tie feature from the secondary tie feature database with at least one primary tie feature from the primary tie feature database within the second search area.

4. The method of claim 1, wherein the step of tie feature matching further comprises the steps of:
forward matching tie features in the primary image with tie features in the secondary image to obtain a first number of tie feature matches; and
backward matching tie features in the secondary image with tie features in the primary image to obtain a second number of tie feature matches.

5. The method of claim 4, further comprising:
validating the secondary image when the first number of tie features and the second number of tie features equal one another.

6. The method of claim 4, further comprising:
invalidating the secondary image when the first number of tie features and the second number of tie features are different from one another.

7. The method of claim 1, wherein the step of tie feature matching further comprises:
drawing a first pair of lines from the centerpoints of two tie features in the primary image to centerpoints of two tie features in the secondary image.

8. The method of claim 7, further comprising:
validating the secondary image when a first number of tie features and a second number of tie features equal one another.

9. The method of claim 7, further comprising:
invalidating the secondary image when a first number of tie features and a second number of tie features are different from one another.

10. The method of claim 7, further comprising:
drawing a second pair of lines, wherein when the first pair of lines or the second pair of lines are free from intersecting one another between the primary and secondary images, the method further comprises:
georegistering the secondary image.

11. A computer program product including one or more non-transitory machine-readable mediums encoded with instructions thereon that when executed by one or more processors cause a process to be carried out for georegistering a target of a plurality of targets, the instructions comprising:
load a primary image that has been georegistered;
load a secondary image;
generate a primary tie feature database from primary tie features detected in the primary image;
generate a secondary tie feature image database from secondary tie features detected in the secondary image;
match at least one secondary tie feature from the secondary tie feature database with at least one primary tie feature from the primary tie feature database within a first search area; and
georegister the secondary image.

12. The computer program product of claim 11, wherein the instructions further comprise:
match tie features within a second search area different from the first search area.

13. The computer program product of claim 11, wherein the instructions further comprise:
narrow the first search area to a second search area smaller than the first search area; and,
match at least one secondary tie feature from the secondary tie feature database with at least one primary tie feature from the primary tie feature database within the second search area.

14. The computer program product of claim 11, wherein the instructions further comprise:
forward match tie features in the primary image with tie features in the secondary image to obtain a first number of tie feature matches;
backward match tie features in the secondary image with tie features in the primary image to obtain a second number of tie feature matches.

15. The computer program product of claim 14, wherein the instructions further comprise:
validate the secondary image when the first number of tie features and the second number of tie features equal one another.

16. The computer program product of claim 14, wherein the instructions further comprise:
invalidate the secondary image when the first number of tie features and the second number of tie features are different from one another.

17. The computer program product of claim 11, wherein the instructions further comprise:
draw a pair of lines from the centerpoints of two tie features in the primary image to centerpoints of two tie features in the secondary image.

18. The computer program product of claim 17, wherein the instructions further comprise:
validate tie features in the secondary image when the lines are free from intersecting one another between the primary and secondary images.

19. The computer program product of claim 17, wherein the instructions further comprise:
invalidate tie features in the secondary image when the lines intersect one another between the primary and secondary images.

20. The computer program product of claim 19, wherein the instructions further comprise:
draw a second pair of lines, wherein when the second pair of lines are free from intersecting one another between the primary and secondary images, the instructions further comprise:
georegister the tie features in the secondary image.
